(19) United States
(12) Patent Application Publication
(10) Pub. No.: US 2011/0185860 A1
(43) Pub. Date: Aug. 4, 2011

(54) Socket Assembly

(76) Inventor: Maan-Jyi Chang, We-Jih Hsiang (TW)

(21) Appl. No.: 12/698,304

(22) Filed: Feb. 2, 2010

(51) Int. Cl. B25B 13/06

(52) U.S. Cl. 81/124.6

(57) ABSTRACT

A socket assembly includes a socket body and a mounting member mounted on the socket body. The mounting member has an inner periphery provided with a mounting hole mounted on an outer periphery of the socket body and has an outer periphery having a non-circular shape. Thus, the outer periphery of the mounting member has a color layer so that the operator can identify the size and specification of the socket body by the color of the outer periphery of the mounting member. In addition, the mounting member has an outer periphery having a non-circular shape so that when the socket body is placed on the ground, the socket body will not roll on the ground by limit of the outer periphery of the mounting member to facilitate the operator taking the socket body.

### BACKGROUND OF THE INVENTION

1. Field of the Invention

The present invention relates to a hand tool and, more particularly, to a socket assembly that can co-operate with a driving tool, such as a ratchet wrench and the like, to rotate a workpiece, such as a bolt and the like.

2. Description of the Related Art

A conventional socket has a first end provided with a hexagonal mounting recess mounted on a hexagonal workpiece, such as a bolt, a screw and the like, and a second end provided with a square connecting hole connected with a square stud of a driving tool, such as a ratchet wrench and the like. The outer periphery of the socket has a circular shape. When in use, the square stud of the ratchet wrench is inserted into the square connecting hole of the socket. Then, the hexagonal mounting recess of the socket is mounted on the hexagonal bolt. Thus, the ratchet wrench can drive and rotate the bolt by co-operation of the socket. However, when many sockets are arranged, the sockets have similar shapes so that the operator cannot identify the sizes and specifications of the sockets easily and quickly, thereby greatly causing inconvenience to the operator when needing to operate the sockets of different sizes. In addition, the outer periphery of the socket has a circular shape so that when the socket is placed on the ground, the socket easily rolls on the ground, thereby causing difficulty to the operator to search for the socket. Further, the outer periphery of the socket has a circular shape so that the operator cannot hold the socket to rotate the socket relative to the workpiece easily and quickly.

### BRIEF SUMMARY OF THE INVENTION

In accordance with the present invention, there is provided a socket assembly, comprising a socket body and a mounting member mounted on the socket body and having an inner periphery provided with a mounting hole mounted on an outer periphery of the socket body. The mounting member has an outer periphery having a non-circular shape.

Preferably, the outer periphery of the mounting member has a hexagonal shape.

Preferably, the outer periphery of the mounting member has a surface provided with a color layer.

Preferably, the outer periphery of the mounting member has a size greater than that of the outer periphery of the socket body.

Preferably, the mounting hole of the mounting member has a size flush with that of the outer periphery of the socket body.

Preferably, the outer periphery of the socket body has a circular shape, and the mounting hole of the mounting member has a circular shape.

Preferably, the mounting hole of the mounting member is closely mounted on the outer periphery of the socket body.

Preferably, the socket body has a first end provided with a hexagonal mounting recess and a second end provided with a square connecting hole.

Preferably, the outer periphery of the socket body has a surface provided with an annular retaining groove, and the mounting member is closely mounted in the retaining groove of the socket body.

Preferably, the retaining groove of the socket body is connected to the mounting hole of the mounting member.

Preferably, the socket body has a first end provided with a square connecting hole and a second end provided with a hexagonal drive head.

Preferably, the outer periphery of the mounting member has a plurality of faces each provided with an arc-shaped recess.

The primary objective of the present invention is to provide a socket assembly having an identification function.

According to the primary objective of the present invention, the outer periphery of the mounting member has a color layer to indicate the size and specification of the socket body to provide an identification function so that the operator can identify the size and specification of the socket body by the color of the outer periphery of the mounting member.

According to another objective of the present invention, the mounting member has an outer periphery having a non-circular shape so that when the socket body is placed on the ground, the socket body will not roll on the ground by limit of the outer periphery of the mounting member to facilitate the operator taking and picking up the socket body.

According to a further objective of the present invention, the mounting member has an outer periphery having a non-circular shape so that the operator can hold the outer periphery of the mounting member to rotate the socket body relative to the workpiece easily and quickly.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a socket assembly in accordance with the preferred embodiment of the present invention.

FIG. 2 is an exploded perspective view of the socket assembly as shown in FIG. 1.

FIG. 3 is an exploded perspective view of a socket assembly in accordance with another preferred embodiment of the present invention.

FIG. 4 is a perspective view of a socket assembly in accordance with another preferred embodiment of the present invention.

FIG. 5 is a perspective view of a socket assembly in accordance with another preferred embodiment of the present invention.

### DETAILED DESCRIPTION OF THE INVENTION

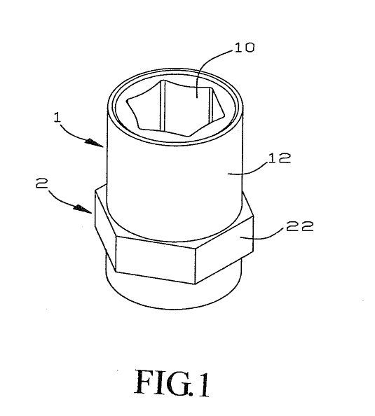

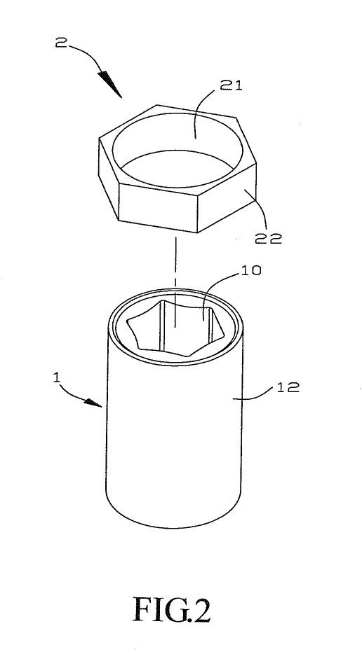

Referring to the drawings and initially to FIGS. 1 and 2, a socket assembly in accordance with the preferred embodiment of the present invention comprises a socket body 1 and a mounting member 2 mounted on the socket body 1 and having an inner periphery provided with a mounting hole 21 closely mounted on an outer periphery 12 of the socket body 1.

The socket body 1 has a first end provided with a hexagonal mounting recess 10 mounted on a hexagonal workpiece, such as a bolt and the like, and a second end provided with a square connecting hole connected with a square stud of a driving tool, such as a ratchet wrench and the like. The outer periphery 12 of the socket body 1 has a circular shape.

The mounting member 2 has an outer periphery 22 having a non-circular shape. In the preferred embodiment of the present invention, the outer periphery 22 of the mounting member 2 has a hexagonal shape. The outer periphery 22 of the mounting member 2 has a surface provided with a color layer. The outer periphery 22 of the mounting member 2 has a size greater than that of the outer periphery 12 of the socket body 1. The mounting hole 21 of the mounting member 2 has a size flush with that of the outer periphery 12 of the socket body 1. The mounting hole 21 of the mounting member 2 has a circular shape.

When in use, the square stud of the ratchet wrench is inserted into the square connecting hole of the socket body 1. Then, the hexagonal mounting recess 10 of the socket body 1 is mounted on the hexagonal bolt. Thus, the ratchet wrench can drive and rotate the bolt by co-operation of the socket body 1.

Accordingly, the outer periphery 22 of the mounting member 2 has a color layer to indicate the size and specification of the socket body 1 to provide an identification function so that the operator can identify the size and specification of the socket body 1 by the color of the outer periphery 22 of the mounting member 2. In addition, the mounting member 2 has an outer periphery 22 having a non-circular shape so that when the socket body 1 is placed on the ground, the socket body 1 will not roll on the ground by limit of the outer periphery 22 of the mounting member 2 to facilitate the operator taking and picking up the socket body 1. Further, the mounting member 2 has an outer periphery 22 having a non-circular shape so that the operator can hold the outer periphery 22 of the mounting member 2 to rotate the socket body 1 relative to the workpiece easily and quickly.

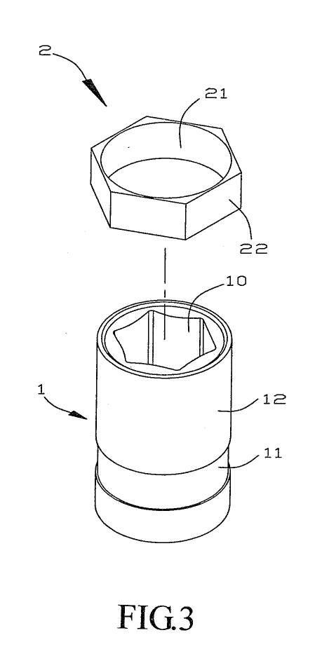

Referring to FIG. 3, the outer periphery 12 of the socket body 1 has a surface provided with an annular retaining groove 11, and the mounting member 2 is closely mounted in the retaining groove 11 of the socket body 1. The retaining groove 11 of the socket body 1 is connected to the mounting hole 21 of the mounting member 2.

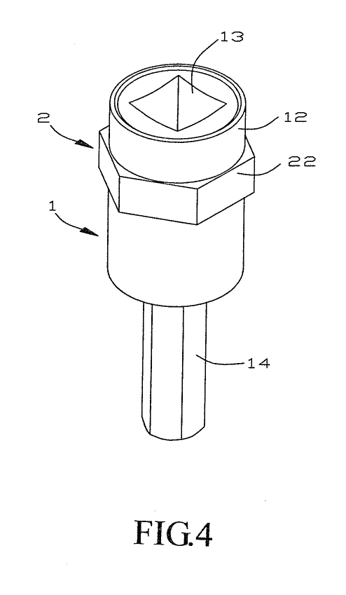

Referring to FIG. 4, the socket body 1 has a first end provided with a square connecting hole 13 connected with a square stud of a driving tool, such as a ratchet wrench and the like, and a second end provided with a hexagonal drive head 14 mounted on a hex-hole workpiece, such as a hex-hole bolt, screw and the like.

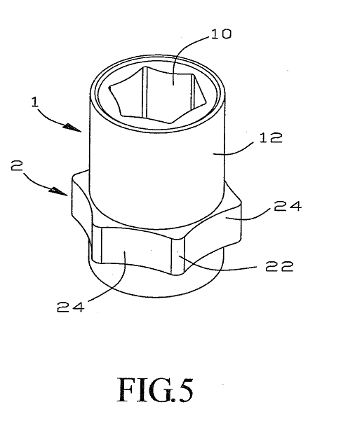

Referring to FIG. 5, the outer periphery 22 of the mounting member 2 has a plurality of faces each provided with an arc-shaped recess 24.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A socket assembly, comprising:
a socket body; and
a mounting member mounted on the socket body and having an inner periphery provided with a mounting hole mounted on an outer periphery of the socket body.

2. The socket assembly of claim 1, wherein the mounting member has an outer periphery having a non-circular shape.

3. The socket assembly of claim 2, wherein the outer periphery of the mounting member has a hexagonal shape.

4. The socket assembly of claim 2, wherein the outer periphery of the mounting member has a surface provided with a color layer.

5. The socket assembly of claim 2, wherein the outer periphery of the mounting member has a size greater than that of the outer periphery of the socket body.

6. The socket assembly of claim 2, wherein the mounting hole of the mounting member has a size flush with that of the outer periphery of the socket body.

7. The socket assembly of claim 2, wherein
the outer periphery of the socket body has a circular shape;
the mounting hole of the mounting member has a circular shape.

8. The socket assembly of claim 1, wherein the mounting hole of the mounting member is closely mounted on the outer periphery of the socket body.

9. The socket assembly of claim 1, wherein the socket body has a first end provided with a hexagonal mounting recess and a second end provided with a square connecting hole.

10. The socket assembly of claim 2, wherein
the outer periphery of the socket body has a surface provided with an annular retaining groove;
the mounting member is closely mounted in the retaining groove of the socket body.

11. The socket assembly of claim 10, wherein the retaining groove of the socket body is connected to the mounting hole of the mounting member.

12. The socket assembly of claim 1, wherein the socket body has a first end provided with a square connecting hole and a second end provided with a hexagonal drive head.

13. The socket assembly of claim 2, wherein the outer periphery of the mounting member has a plurality of faces each provided with an arc-shaped recess.
